(19) United States
(12) Patent Application Publication
(10) Pub. No.: US 2006/0211957 A1
(43) Pub. Date: Sep. 21, 2006

(54) Device for mobilisation of the lower limbs

(76) Inventors: Laurent Beny, Charroue (FR); Jose Andry, Bourg Fidele (FR)

Correspondence Address: CLARK & BRODY, 1090 VERMONT AVENUE, NW, SUITE 250, WASHINGTON, DC, 20005, US

(21) Appl. No.: 11/373,297

(22) Filed: Mar. 13, 2006

Related U.S. Application Data
(60) Provisional application No. 60/663,758, filed on Mar. 22, 2005.

(30) Foreign Application Priority Data
Mar. 14, 2005 (FR) FR 05 02467

(51) Int. Cl. A61H 1/02

(52) U.S. Cl. 601/5; 601/35; 601/33

(57) ABSTRACT

The device for mobilisation of the lower limbs includes an elongated base (2), two distal slides (15) and two distinct leg supports (7), each of which is linked, at its distal end, by a hinge (17), to a distal slide (15). According to the invention, the device includes:

at the base (2), two curved guidance tracks (6) both lying in a vertical plane (P′),

and two proximal slides (19) each of which is mobile in translation along one of the curved guidance tracks (6), where each of the two leg supports (7) is connected, at its proximal end, by a hinge, to a proximal slide (19), so that during a displacement in translation of each distal slide along the corresponding rectilinear guidance track, the corresponding leg support undergoes a combined rotation and translation movement.

This present invention concerns the technical area of devices used for the re-education and mobilisation of the lower limbs. In a preferred but non-exclusive implementation, the invention concerns mobilisation devices, particularly those designed for re-educating the articulation of the knee of a patient.

In the aforementioned area, U.S. Pat. No. 2,772,881 proposes a re-education device which includes an elongated base equipped at the top with two rectilinear slots parallel to each other. The re-education device also includes, within the base, an endless belt which runs between two guidance pulley wheels and whose two sides are located opposite to the rectilinear slots. The re-education device also includes two fingers, each fixed to a side of the pulley wheel and each inserted through a rectilinear slot, so that each drives an articulated foot-rest support. This re-education device is intended to be used in a bed, where the patient places each of his or her two feet on a support. Thus, given the relationship between the two supports, when the patient extends a leg, pushing on the corresponding support, this automatically induces a bending movement of the other leg in the reverse direction.

Such a re-education and exercise device can therefore be used to achieve mobilisation of the two lower limbs for a patient reclining in a bed. However, it has to be said that such a re-education device does not provide effective guidance of the lower limbs and, more particularly, of the legs of the user, to the extent that it is not certain that the force developed by the latter does not drive the joints of the lower limbs, and particularly those of the knees, in an appropriate manner.

Thus, a need has arisen for a mobilisation and re-education device which is capable of guaranteeing the correct kinetic nature of the movement of the lower limbs, in order to prevent damage to the joints or premature fatiguing of the patient using the mobilisation device.

In order to meet this objective, the invention concerns a device for mobilisation of the lower limbs that includes:
an elongated base which includes two rectilinear guidance tracks that are parallel to each other,
two distal slides, each of which is mobile in translation along one of the guidance tracks,
and two separate left and right leg supports each of which is linked, at its distal end, by a hinge, to a distal slide, these being intended to support the two lower limbs on the left and right.

According to the invention, this device for mobilisation of the lower limbs is characterised in that it includes, in addition:
at the base, two curved guidance tracks both lying in a vertical plane,
and two proximal slides, each of which is mobile in translation along one of the curved guidance tracks, with each of the two leg supports being linked, at its proximal end, by a hinge, to a proximal slide, so that during a displacement in translation of each distal slide, along the corresponding rectilinear guidance track, the corresponding leg support undergoes a combined rotation and translation movement.

To a highly advantageous degree, the provision of leg supports allows the two lower limbs to be guided in their movements, thus avoiding any inappropriate stressing of the joints, and eliminates premature fatiguing of the user of the mobilisation device. Moreover, the guidance of each leg support by the corresponding distal and proximal slides, results in a high degree of lateral stability of the leg support.

According to one characteristic of the invention, the rectilinear and curved guidance tracks are designed so that the slope of each leg support, in relation to the corresponding rectilinear guidance track, reduces when the corresponding distal slide moves toward a distal end of the rectilinear guidance track. This characteristic of the invention is particularly suitable for the implementation of a mobilisation device according to the invention that is intended to be used in a reclining position of the user or patient.

According to another characteristic of the invention, the concave sides of the curved guidance tracks are oriented toward the proximal end of the rectilinear guidance tracks. This characteristic of the invention contributes to conferring upon the displacement of each leg support a trajectory that matches the natural anatomic trajectory of the leg during the bending and extension movements of the lower limb of the patient.

According to yet another characteristic of the invention, and in order confer upon each of the leg supports a trajectory which is as anatomical as possible, each curved guidance track has a more or less rectilinear proximal part, which is extended by a curved part that, preferably but not necessarily, has a radius of curvature of between 80 mm and 300 mm.

Still with the objective of conferring a trajectory which is as anatomical as possible upon each of the leg supports, and according to another characteristic of the invention, for each leg support, the distance between, firstly, the point of articulation of the leg support on the distal slide and, secondly, the point of articulation of the leg support on the proximal slide, is between 280 mm and 300 mm.

According to another characteristic of the invention, aiming to increase the lateral stability of the mobilisation device, the rectilinear guidance tracks are extended in a plane which is perpendicular to the vertical planes of the curved guidance tracks.

According to a preferred but not strictly necessary form of implementation, aiming to reduce the overall size of the mobilisation device, the curved guidance tracks are placed between the leg supports. Thus, the curved guidance tracks can be supported by a single extension from the base of the device. Of course, one could also envisage placing the curved guidance tracks on either side of the leg supports.

According to another characteristic of the invention, in order to allow adaptation to the needs of the user or patient of the movements permitted by the mobilisation device, the latter includes resources for adjusting the amplitude of the translation movements of the distal and/or proximal slides.

According to yet another characteristic of the invention, aiming to allow adaptation of the trajectory of the leg supports to suit the size of the user, the mobilisation device includes resources for adjusting the distance between the distal slide and the corresponding proximal slide, for each leg support.

According to another characteristic of the invention, aiming to provide improved comfort for the user, each leg support includes a calf support and a foot rest hinged on the calf support. Of course, according to the invention, the foot rest could be fixed in relation to the calf support and not allow any adjustment of their relative orientation.

According to a preferred but not strictly necessary form of implementation of the invention, aiming to guarantee the opposite character of the displacements of the two leg supports, the mobilisation device includes transmission resources that are designed to ensure that the two distal and/or proximal slides have opposite movements in relation to each other. In a variant of this preferred form of implementation, the transmission resources connect the distal slides through a system of belts and of guidance pulley wheels. Of course, according to the invention, the transmission resources could also be implemented in any other appropriate manner, such as in the form of hydraulic actuators whose chambers communicate as described in U.S. Pat. No. 4,946,162.

According to one characteristic of the invention, the transmission resources include motor-drive resources that are designed to drive the distal slides in translation. This characteristic of the invention thus allows passive mobilisation of the lower limbs of the patient to be achieved using the mobilisation device according to the invention.

According to another characteristic of the invention, the transmission resources include braking resources with adjustable resistance, designed to allow adjustment of the force necessary to ensure a displacement in translation of the distal slides. The implementation of this characteristic allows the mobilisation device according to the invention to be used in the context of a re-education programme aiming to enable the patient to recover the muscular mass of the lower limbs.

According to yet another characteristic of the invention, the mobilisation device includes, firstly, motor-drive resources that include at least one distinct motor for each leg support and, secondly, a control unit for the motor-drive resources designed to ensure the displacement of the leg supports in different combinations, such as synchronised opposite displacements of the leg supports or synchronised displacements of the leg supports in the same direction.

Of course, the different characteristics of the invention mentioned above can be implemented with each other in different combinations, when they are not exclusive to each other or incompatible.

Various other characteristics of the invention emerge from the description provided below with reference to the appended figures which show, by way of non-limited examples, forms of implementation of the subject of the invention.

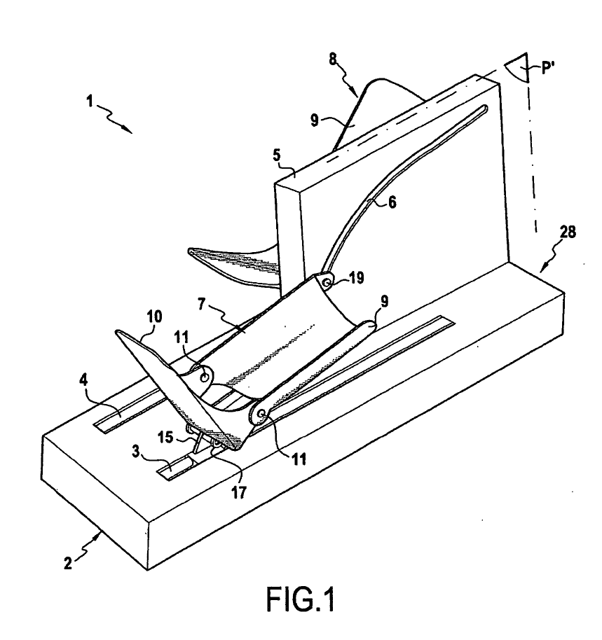

FIG. 1 is a view in perspective of a device for mobilisation of the lower limbs according to the invention.

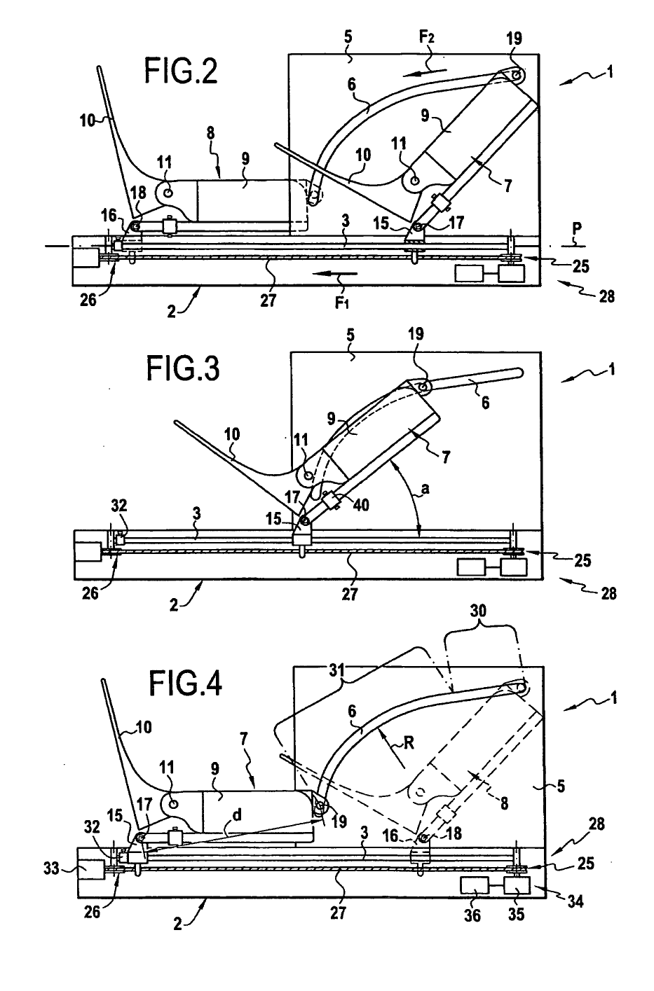

FIG. 2 is a view in elevation, partially drawn out, of the mobilisation device as illustrated in FIG. 1, showing the mobilisation device in a state corresponding to bending of the lower left limb and extension of the lower right limb.

FIGS. 3 and 4 are views in elevation, similar to FIG. 2, showing different stages of the passage of the mobilisation device according to invention to a state corresponding to extension of the lower left limb and to bending of the lower right limb.

A mobilisation device according to the invention as illustrated in FIG. 1 and designated as a whole by the reference 1, is intended to allow the exercising or the re-education of one or both lower limbs of a user, who is not shown.

The device 1 includes an elongated base 2 which is provided with two rectilinear guidance tracks 3 and 4. The two rectilinear tracks 3 and 4 are parallel to each other and form a plane P that is designed, according to the illustrated example, to have a more or less horizontal orientation, as shown in FIG. 2. The base 2 includes a vertical extension 5 which is equipped with curved guidance tracks 6, each lying in a vertical plane P′ that is perpendicular to plane P. The two curved guidance tracks 6 are each placed on either side of the vertical extension 5, so that only the left curved guidance track is visible in the figures.

In order to cater for the legs of the user, the mobilisation device 1 also includes two leg supports, respectively left 7 and right 8. According to the invention, the two leg supports 7 and 8 are distinct from each other, to the extent that they do not form a single-block assembly. The right leg support 7 is intended to receive the lower right limb while the left leg support 8 is intended to receive the lower left limb. According to the illustrated example, each leg support 7, 8 includes a calf support 9 and a foot rest 10 hinged onto the calf segment 9 by means of two pivots 11 whose axes are more or less horizontal. Of course, according to the invention, the calf segment 9 and the foot rest 10 could also form a single-block, non-articulated assembly. Each leg support 7, 8 is also linked firstly to a rectilinear guidance track 3, 4, and secondly to a curved guidance track 6. To this end, the rectilinear guidance tracks 3, 4 each includes a distal slide, respectively 15 and 16, which is linked by a hinge 17, 18 to a distal end of the corresponding leg support, 7 and 8 respectively) . According to the illustrated example, the joints 17 and 18 are formed by pivots with horizontal axes that are more or less perpendicular to the rectilinear guidance tracks 3, 4. In like manner, the curved guidance tracks 6 each includes a proximal slide 19 which is linked by a hinge to the proximal end of the corresponding leg support. According to the illustrated example, the articulation connecting each leg support to the corresponding proximal slide is formed by a pivot with a more or less horizontal axis that is perpendicular to the planes P′ of the curved guidance tracks 6.

According to the form of implementation of the invention illustrated in the figures, the mobilisation device 1 also includes transmission resources 25 designed to provide the two distal trolleys 15, 16 with movements that are opposite to each other, as will be shown in what follows. The transmission resources 25 can be implemented in any appropriate manner and, in accordance with the illustrated example, these transmission resources 25 include guidance pulley wheels 26 placed at the distal and proximal ends of the rectilinear guidance tracks 3, 4. The transmission resources 25 also include an endless belt 27 which runs between the pulley wheels 26, and whose two sides are each located in relation to a rectilinear guidance track 3 or 4. Each distal slide 15, 16 is then linked to a different side of the belt 27, so that when a distal slide is located at one end of its rectilinear guidance track, the other distal slide is located at the opposite end of its own rectilinear guidance track.

Thus, as shown in FIG. 2, when the left leg support 7 is in a position corresponding to bending of the lower left limb, the right leg support 8 is in a position corresponding to extension of the lower right limb. In this state, when pressure is applied to the left leg support 7, the distal slide 15 moves in rectilinear translation in the direction of arrow F₁, while the distal slide 16 moves in opposite direction. In like manner, the right proximal slide 19 moves along the curved guidance track 6 in the direction of arrow F₂, and the right proximal slide moves in the opposite direction. Given the form of the curved guidance track 6 whose concave side is oriented toward the proximal end 28 of the rectilinear guidance tracks 3, 4, the right leg support 7 experiences a displacement which is a combination of translation and rotation, in order, passing through the position illustrated in FIG. 3, to reach the state represented in FIG. 4, corresponding to a position of extension of the lower left limb. In a similar manner, the left leg support 8 experiences a reverse or opposite displacement, to reach the position, as illustrated in FIG. 4, of bending of the lower right limb. It should be noted that during the displacement of the left slide 15 in the direction of arrow F₁, the angle (a) formed by the left leg support 7 with the rectilinear guidance track 3 progressively reduces.

According to a preferred but non-exclusive form of implementation, in order to confer a displacement which is as anatomically correct as possible upon the leg support 7, 8, each guidance track has a rectilinear proximal part 30 which is extended by a curved part 31 whose radius of curvature (R) is between 80 mm and 300 mm. According to the illustrated example, the curved part 31 is not a circular arc but has a radius of curvature which varies along the part 31. This characteristic of the invention results in a movement of the lower limbs which is as natural as possible, avoiding painful stresses on the joints of the latter and, particularly, on the knee joints. Still for the purpose of achieving a displacement which is as anatomical as possible, the distance (d) between the articulation of a leg support on the distal slide and the articulation of the same leg support on the proximal slide, is chosen to be between 280 mm and 300 mm.

According to the illustrated example, the mobilisation device 1 also includes resources 32 for adjusting the amplitude of the movement of the leg segments 7, 8. This adjustment of the amplitude of the movement of the segments can be achieved by any adjustment of the amplitude of the translation of the distal and/or proximal trolleys. According to the illustrated example, the adjustment resources 32 include an end-stop whose position on the rectilinear guidance track 3 is adjustable.

According to the illustrated example, the mobilisation device 1 also includes braking resources 33 whose resistance is adjustable so as to allow adjustment of the force necessary to ensure a displacement in translation of the distal and/or proximal trolleys. According to the illustrated example, the adjustable braking resources 33 are designed to act upon one of the pulley wheels 26 by braking its rotation to a greater or lesser extent. This braking can be achieved in any appropriate manner such as by a roller that presses more or less onto the pulley wheel 26.

The illustrated example also shows the possibility of implementing motor-drive resources 34, such as a electric motor 35 commanded by a control unit 36, which drives one of the pulley wheels 26 so as to drive the alternating displacement in translation of the distal trolleys 15, 16.

Of course various modifications can be made to the aforementioned mobilisation device without moving outside the scope of this present invention. Thus, in order to change the amplitude of the displacement of the leg segments 7, 8, resources 40 can be provided for each leg segment that will allow any adjustment of the distance (d) between the joints of the said leg segment on the proximal slide and the distal slide.

1. A device for mobilisation of the lower limbs, which includes:
an elongated base (2) which includes two rectilinear guidance tracks (3, 4) parallel to each other, two distal slides (15, 16), each of which is mobile in translation along one of the rectilinear guidance tracks (3, 4), and two distinct leg supports, left (7) and right (8), each of which is linked, at its distal end, by a hinge (17, 18) to a distal slide (15, 16), these being intended to support the left and right lower limbs, characterised in that it includes:
at the base (2), two curved guidance tracks (6) both lying in a vertical plane (P′), and
two proximal slides (19), each of which is mobile in translation along one of the curved guidance tracks (6), the two leg supports (7, 8) each being connected, at its proximal end, by an articulation or hinge to a proximal slide (19), so that during a displacement in translation of each distal slide, along the corresponding rectilinear guidance track, the corresponding leg support undergoes a combined rotation and translation movement.

2. A mobilisation device according to claim 1, characterised in that the rectilinear (3, 4) curved guidance tracks (6) are designed so that the slope of each leg support in relation to the corresponding rectilinear guidance track reduces when the corresponding distal slide moves toward a distal end of the rectilinear guidance track.

3. A mobilisation device according to claim 1, characterised in that the concave sides of the curved guidance tracks (6) are oriented toward the proximal end (28) of the rectilinear guidance tracks.

4. A mobilisation device according to claim 1, characterised in that each curved guidance track (6) has a proximal part (30) that is more or less rectilinear, and which is extended by a curved part (31) that has a radius of curvature (R) of between 80 mm and 300 mm.

5. A mobilisation device according to claim 1, characterised in that the rectilinear guidance tracks (3, 4) are extended in a plane (P) that is perpendicular to the vertical planes (P′) of the curved guidance tracks (6).

6. A mobilisation device according to claim 1, characterised in that the curved guidance tracks (6) are placed between the leg supports (7, 8).

7. A mobilisation device according to claim 1, characterised in that it includes resources (32) for adjusting the amplitude of the translation of the distal and/or proximal slides.

8. A mobilisation device according to claim 1, characterised in that each leg support includes a calf support (9), and a foot rest (10) that is hinged onto the calf support.

9. A mobilisation device according to claim 1, characterised in that it includes transmission resources (25) designed to provide the two distal and/or proximal slides with movements that are opposite to each other.

10. A mobilisation device according to claim 9, characterised in that the transmission resources (25) include motor-drive resources (34) that are designed to drive the distal slides in translation.

11. A mobilisation device according to claim 9, characterised in that the transmission resources (25) include braking resources (33) with adjustable resistance, designed to allow adjustment of the force necessary to ensure a displacement in translation of the distal slides.

12. A mobilisation device according to claim 1, characterised in that, for each leg support (7, 8), the distance (d) between, firstly, the point of articulation of the leg support on the distal slide and, secondly, the point of articulation of the leg support on the proximal slide, is between 280 mm and 300 mm.

13. A mobilisation device according to claim 1, characterised in that it includes, for each leg support, resources (40) to adjust the distance between the distal slide and the corresponding proximal slide.
